(19) United States
(12) Patent Application Publication
(10) Pub. No.: US 2026/0314512 A1
(43) Pub. Date: Oct. 15, 2026

(54) MOBILE APPARATUS WITH A DEVICE ADAPTED FOR REMOVING DEW FROM GRASS

(71) Applicant: TinyMobileRobots ApS, Malling (DK)

(72) Inventors: Oliver Evald Hansen, Aarhus C (DK); Soren Thorenfeldt Ingwersen, Aarhus C (DK)

(21) Appl. No.: 19/485,113

(22) PCT Filed: May 27, 2024
(86) PCT No.: PCT/EP2024/064501

§ 371 Date: Nov. 17, 2025

(30) Foreign Application Priority Data
Jun. 1, 2023 (DK) PA202330056

(51) Int. Cl. A01B 45/00; A01B 73/04; A01G 20/40; A63B 57/50

(52) U.S. Cl. CPC A01B 45/00; A01B 73/044; A01G 20/40; A63B 57/50

(57) ABSTRACT

The present invention relates to a mobile robot comprising a chassis and a device adapted for removing dew from grass.

### TECHNICAL FIELD OF THE INVENTION

The present invention relates to a mobile apparatus with a device adapted for removing dew from grass.

### BACKGROUND OF THE INVENTION

In the field of maintenance of fine turf for sports fields, such as golf courses, sweeping or brushing of the grass is widely used for a number of reasons.

Sweeping of the grass is especially necessary on putting greens, being the area of the golf course with very precisely cut turf on smooth, firm ground surrounding the holes. The turf of the greens is generally cut daily in order to obtain optimum performance, and it is often desirable to remove dew before cutting.

Furthermore, it is desirable to remove the dew early in the morning due to risk of fungal diseases. Greens are also swept to remove worm castings, which can dull the precision cutting blades of the greens mowers. Brushing or sweeping can also be performed prior to mowing so as to make the grass stand up against the mowing direction to achieve a better cut, and brushing can also be used to force sand and other particles down between the blades of the grass after application of top dressing. Furthermore, brushing can be performed after cutting or rolling of the greens to remove possible grass clippings and small debris and to improve the appearance of the putting surface.

Generally, when talking of dew removal, it should be understood, that the dew is not removed but rather forced down from the grass blades onto the soil surface.

Today, the sweeping operation is often performed by using a long, thin fibreglass rod (swishing or whipping) or by a vehicle mounted brush system. Swishing is a tedious task and difficult to perform to a high standard, and vehicle mounted brush systems will increase the wear on the sensitive greens areas.

### OBJECT OF THE INVENTION

The object of the present invention is to provide an automated dew removal device, which overcomes the above drawbacks of the prior art techniques.

### SUMMARY OF THE INVENTION

One aspect of the present invention relates to a mobile apparatus, such as a mobile marking robot, comprising:
a chassis; and
a device adapted for removing dew from grass; said device being adapted for being in an active state, and an inactive state, wherein said device is adapted for being in a collapsed configuration in its inactive state, and an expanded configuration in its active state.

In one or more embodiments, the device extends beyond the width of the chassis in its active state and is collapsed to a configuration within the width of the chassis in its inactive state.

In one or more embodiments, the device comprises two or more subunits, and wherein said mobile apparatus further comprises:
a control unit adapted for assembling said two or more subunits into the device in its active state and for disassembling said device into said two or more subunits in the device in its inactive state.

According to a further embodiment of the present invention, at least one, preferably two, of said subunits are configured for being moved between a horizontal position, relative to the ground on which the mobile apparatus is operating, when the device is in its active state, and a vertical position, when the device is in its inactive state.

In a preferred embodiment of the present invention, the control unit comprises a linear actuator operatively connected to said subunits.

In one or more embodiments, the subunits comprise a brush part, a chain, or a band of an elastomeric material to ensure proper removal of dew.

In one or more embodiments, at least one, preferably all, of the subunits, comprises an over-center mechanism adapted to provide stability thereto. The over-center mechanism is adapted to provide stability and control to the subunit. The principle behind an over-center mechanism is to use a linkage system that moves past a center pivot point, creating a locking action. This mechanism ensures that the subunit remains stable in a desired position until a force is applied to move it back past the center point.

In one or more embodiments, the over-center mechanism comprises a linkage system, preferably comprising a plurality of linked arms, such as two, or three linked arms. If present, the linkage system is preferably operatively connected to the control unit's linear actuator.

An over-center mechanism typically consists of a series of linked arms or levers (a linkage system) connected to a pivot point. As the linkage system moves, it passes through a center position where the alignment of the components changes. The center point is the pivotal position where the linkage system changes from an unstable to a stable state or vice versa. When the linkage system moves past this center point, the system locks into a stable position. The force exerted by the linkage system past the center point holds the mechanism in place. This can be due to the geometry of the linkage system and the forces acting on it, creating a stable, locked position that resists movement until a deliberate force is applied.

It is advantageous if the mobile apparatus according to the invention comprises a system for locating the flagstick and hole on a golf green.

Such a system can be used to avoid the flagstick when sweeping the greens and can also be used to locate and avoid obstacles during transport between greens. In a preferred embodiment the above locating system is vision or lidar based.

In another preferred embodiment the apparatus comprises a flagstick lifting and lowering system. In this way it is possible for the apparatus to remove the flagstick and subsequently brush across the hole so as to achieve a better brushing of the green.

According to another embodiment of the invention, the flagstick lifting and lowering system is activated by the linear actuator. In this way it is possible to use the power from the linear actuator to lift the flagstick before sweeping the green and lower the flagstick after the operation.

When the dew removal apparatus comprises a mobile robot, it will need to have a localization system telling the robot where it is, and how it is orientated, to be able to mark the data in an area. Furthermore, the data needs to be aligned to the locations system used by the robot. Most commonly used technologies for positioning are total stations and GNSS, but some solutions use advanced localization technologies together with cameras or lidars.

The orientation of the mobile robot can be determined by having two independent location systems placed apart with enough distance to allow the robot to calculate its orientation. Another method of orientation is to let the robot drive a certain distance with one location system, and by driving, it can calculate its orientation. Aligning the robot's localization with the digital data provided requires a shared coordinate system.

If the location system is global, like the GNSS, the global coordinates are sufficient for aligning the data and letting the robot start working.

In one or more embodiments, the positioning system is configured for continuously receiving a positioning signal from a Global Navigation Satellite System (GNSS). Global Navigation Satellite Systems (GNSS) is a collective term for a variety of satellite navigation systems, which use orbiting satellites as navigation reference points to determine position fixes on the ground. GNSS includes the Global Positioning System (GPS), the Global Navigation Satellite System (GLONASS), the Compass system, Galileo, and several Satellite based augmentation systems (SBAS). In typical civilian applications, a single GNSS receiver can measure a ground position with a precision of about ten meters. This is, in part, due to various error contributions, which often reduce the precision of determining a position fix. For example, as the GNSS signals pass through the ionosphere and troposphere, propagation delays may occur. Other factors, which may reduce the precision of determining a position fix, may include satellite clock errors, GNSS receiver clock errors, and satellite position errors. One method for improving the precision for determining a position fix is Real-Time Kinematic (RTK) GNSS. Real Time Kinematic (RTK) satellite navigation is a technique using the phase of the signal's carrier wave, rather than the information content of the signal, and relies on a single reference station or interpolated virtual station to provide real-time corrections.

In one or more embodiments, the positioning system is configured for continuously receiving a positioning signal from a total station. The total station needs to use fix points to calculate its own position as well as the position of the mobile robot. The fix points can be reflectors placed beforehand at known coordinates or it can be fixed points in the construction like corners of walls or windows, that has known coordinates and can be used to localize the total station. The mobile robot may comprise a retroreflector. Any retroreflector with retroreflectors, generally known within the art of land surveying, may be used. In one or more embodiments, the retroreflector is a 360-degree all-around retroreflector.

As an example, and in order for the dew removal apparatus/mobile robot to operate, the control unit may comprise a computing system including a processor, a memory, a communication unit, an output device, an input device, and a data store, which may be communicatively coupled by a communication bus. The mentioned computing system should be understood as an example and that it may take other forms and include additional or fewer components without departing from the scope of the present disclosure. For instance, various components of the computing device may be coupled for communication using a variety of communication protocols and/or technologies including, for instance, communication buses, software communication mechanisms, computer networks, etc. The computing system may include various operating systems, sensors, additional processors, and other physical configurations. The processor, memory, communication unit, etc., are representative of one or more of these components. The processor may execute software instructions by performing various input, logical, and/or mathematical operations. The processor may have various computing architectures to method data signals (e.g., CISC, RISC, etc.). The processor may be physical and/or virtual and may include a single core or plurality of processing units and/or cores. The processor may be coupled to the memory via the bus to access data and instructions therefrom and store data therein. The bus may couple the processor to the other components of the computing system including, for example, the memory, the communication unit, the input device, the output device, and the data store. The memory may store and provide data access to the other components of the computing system. The memory may be included in a single computing device or a plurality of computing devices. The memory may store instructions and/or data that may be executed by the processor. For example, the memory may store instructions and data, including, for example, an operating system, hardware drivers, other software applications, databases, etc., which may implement the techniques described herein. The memory may be coupled to the bus for communication with the processor and the other components of computing system. The memory may include a non-transitory computer-usable (e.g., readable, writeable, etc.) medium, which can be any non-transitory apparatus or device that can contain, store, communicate, propagate, or transport instructions, data, computer programs, software, code, routines, etc., for processing by or in connection with the processor. In some implementations, the memory may include one or more of volatile memory and non-volatile memory (e.g., RAM, ROM, hard disk, optical disk, etc.). It should be understood that the memory may be a single device or may include multiple types of devices and configurations. The input device may include any device for inputting information into the computing system. In some implementations, the input device may include one or more peripheral devices. For example, the input device may include the display unit comprising a touchscreen integrated with the output device, etc. The output device may be any device capable of outputting information from the computing system. The output device may be the display unit, which display electronic images and data output by a processor of the computing system for presentation to a user, such as the processor or another dedicated processor. The data store may include information sources for storing and providing access to data. In some implementations, the data store may store data associated with a database management system (DBMS) operable on the computing system. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations. The data stored by the data store may be organized and queried using various criteria including any type of data stored by them. The data store may include data tables, databases, or other organized collections of data. The data store may be included in the computing system or in another computing system and/or storage system distinct from but coupled to or accessible by the computing system. The data stores can include one or more non-transitory computer-readable mediums for storing the data. In some implementations, the data stores may be incorporated with the memory or may be distinct therefrom. The components may be communicatively coupled by the bus and/or the processor to one another and/or the other components of the computing system. In some implementations, the components may include computer logic (e.g., software logic, hardware logic, etc.) executable by the processor to provide their acts and/or functionality. These components may be adapted for cooperation and communication with the processor and the other components of the computing system.

It should be noted that embodiments and features described in the context of one of the aspects of the present invention also apply to the other aspects of the invention.

### BRIEF DESCRIPTION OF THE FIGURES

FIG. 1 shows a side view of a brush assembly in accordance with various embodiments of the invention in an inactive state.

FIG. 2 shows a side view of a brush assembly in accordance with various embodiments of the invention in an active state.

FIG. 3 shows a rear view of a mobile robot with brush assembly in accordance with various embodiments of the invention in an inactive state.

FIG. 4 shows a front view of a mobile robot with a brush assembly in accordance with various embodiments of the invention in an active state.

### DETAILED DESCRIPTION OF THE INVENTION

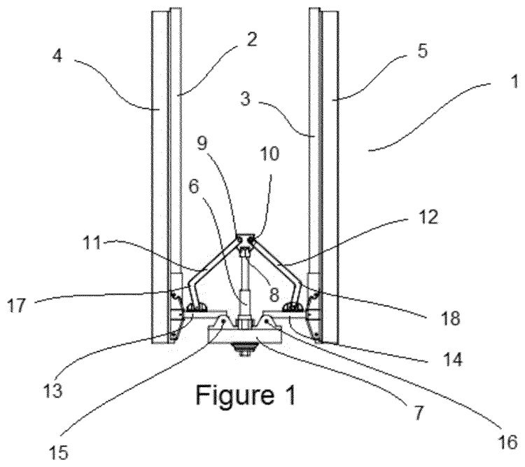

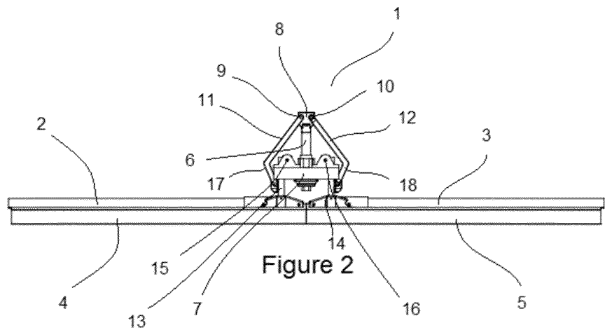

Referring to both FIG. 1 and FIG. 2, the depicted brush assembly device 1 is designed to be mounted on a mobile robot (not shown) which can move the device over a green to remove the dew. The brush assembly device 1 comprises a first and second generally straight brush carrying arms 2, 3 on which the brushes 4, 5 are mounted. The brush carrying arms 2, 3 can be moved between a generally vertical position that is shown in FIG. 1, also known as the inactive position or the transport position, to a generally horizontal position that is shown in FIG. 2 that is the active position with the brushes engaged for dew removal. The movement is controlled by a linear actuator 6 that is mounted on a base 7. At the top end, the linear actuator 6 comprises a plate/bracket 8 with two holes 9, 10 in which two linkage arms 11, 12 are pivotally mounted. At the opposite ends, the linkage arms 11, 12 are pivotally mounted on studs/levers 13, 14 which are fixed to the brush carrying arms 2, 3, and which also has pivot points 15, 16 on the base 7. The base 7 is configured to be mounted on a mobile robot. The linkage arms 11, 12 comprise a bend or a curve 17, 18 so that they can move freely without touching the base 7 when the linear actuator 6 is moved from its extended position in FIG. 1 to its retracted position in FIG. 2.

When the apparatus receives a signal to lower the brushes, the actuator 6 starts to retract. Due to the linkage system the upper ends of the brushes 4, 5 start to move downwards in a generally circular motion. When the brush carrying arms 2, 3 reach a generally horizontal position the motion is stopped, and the brushes 4, 5 will be in engagement with the surface from which the dew is to be removed.

According to an embodiment of the invention, a vision or lidar system can be mounted on the robot for locating the flagstick and hole so that the apparatus can avoid hitting the flagstick when sweeping the green. The apparatus can also be provided with a flagstick lifting device that in combination with the flagstick locating system can be used to lift the flag and carry it around when the area around the hole or the whole green is swept. The flagstick lifting device can be mechanically coupled to the actuator, so that the gripping and lifting motion happens when the brushes are lowered to the active position.

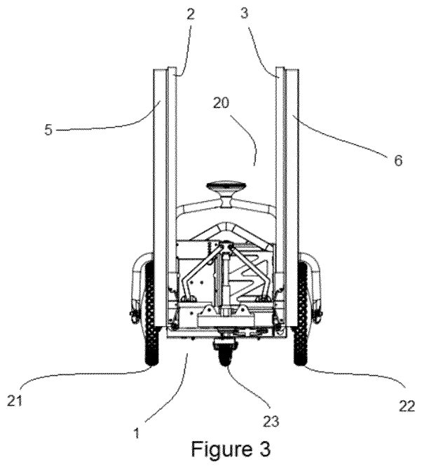

FIG. 3 shows a front view of the mobile apparatus according to the invention. On the front end of a mobile line marker 20, a brush assembly device 1 is mounted. In FIG. 3 the brush assembly device is shown in the inactive (transport) position with the brush carrying arms 2, 3 and the brushes 4, 5 in a vertical position. The mobile line marker 20 comprises 2 larger wheels 21, 22 and a smaller castor wheel. The wheels are shown with coarse tread tyres, but on some sensitive greens it might be preferred to use a finer tread or even slick tyres.

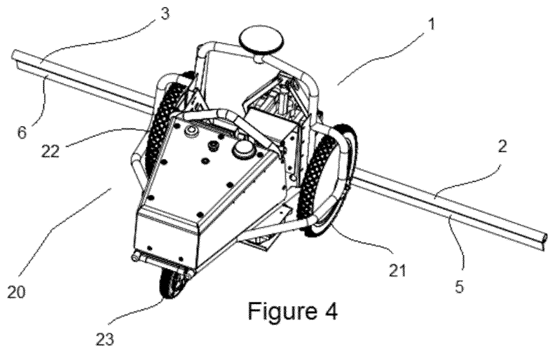

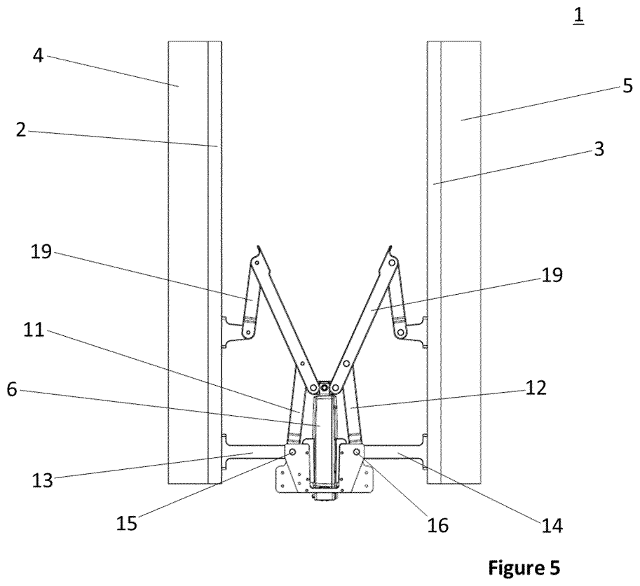

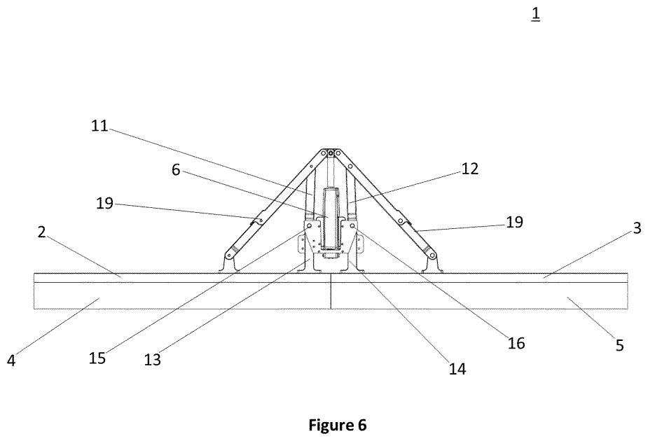

FIG. 4 shows the mobile apparatus according to the invention in front perspective view. In this view, the brush assembly device 1 is shown in its active position with the brush carrying arms 2, 3 and the brushes 4, 5 lowered to a horizontal position.

FIGS. 5 and 6 show another embodiment, where the brush assembly device 1 further comprises an over-center mechanism operably connected to each subunit adapted to provide stability thereto. The over-center mechanism comprises a linkage system 19 (here comprising two linked arms). In this specific embodiment, the two linkage arms 11, 12 are pivotally mounted to the linkage system 19, which in turn is pivotally mounted to a bracket on the linear actuator 6 and to the brush carrying arms 2, 3.

The apparatus according to the invention advantageously comprise a mobile line marking robot as described, but a robot that is custom built for the task can also be used.

### REFERENCES

1 Device
2 Part of first subunit, brush carrying arm
3 Part of second subunit, brush carrying arm
4 Part of first subunit, brush
5 Part of second subunit, brush
6 Linear actuator
7 Base
8 Plate/bracket
9 Hole
10 Hole
11 Linkage arm
12 Linkage arm
13 Stud/lever
14 Stud/lever
15 Fastening means
16 Core
17 Bend/curve
18 Bend/curve
19 Linkage system
20 Mobile line marker
21 Wheel
22 Wheel

1. A mobile marking robot, comprising:
a chassis; and
a device adapted for removing dew from grass;
wherein the device is adapted for being in an active state, and an inactive state, wherein the device is further adapted for being in a collapsed configuration in its inactive state, and an expanded configuration in its active state;
wherein the device comprises two or more subunits, and wherein said mobile marking robot comprises:
a control unit adapted for assembling said two or more subunits into the device in its active state and for disassembling said device into said two or more subunits in the device in its inactive state; wherein at least one of said subunits are configured for being moved between a horizontal position, relative to the ground on which the mobile marking robot is operating, when the device is in its active state, and a vertical position, when the device is in its inactive state.

2. The mobile marking robot according to claim 1, wherein said device extends beyond the width of the chassis in its active state and is collapsed to a configuration within the width of the chassis in its inactive state.

3. The mobile marking robot according to claims 1, wherein at least one, preferably all, of said subunits, comprises an over-center mechanism adapted to provide stability thereto.

4. The mobile marking robot according to claim 3, wherein said over-center mechanism comprises a linkage system.

5. The mobile marking robotmobile according to claims 1, wherein the control unit comprises a linear actuator operatively connected to said subunits.

6. The mobile marking robotmobile according to claims 1, wherein each of said subunits comprises a brush part, a chain, or a band of an elastomeric material.

7. The mobile marking robotmobile according to claim 1, wherein the mobile marking robot comprises a system for locating the flagstick and hole on a golf green.

8. The mobile marking robot according to claim 7, wherein the locating system is vision or lidar based.

9. The mobile marking robot according to claim 1, wherein the mobile marking robot comprises a flag lifting and lowering system.

10. The mobile marking robot according to claim 9, wherein the device comprises two or more subunits, and wherein said mobile marking robot further comprises:
a control unit adapted for assembling said two or more subunits into the device in its active state and for disassembling said device into said two or more subunits in the device in its inactive state; wherein the control unit comprises a linear actuator (6) operatively connected to said subunits, and wherein the flag lifting and lowering system is activated by the linear actuator.

11. The mobile marking robot according to claim 1, wherein at least two of said subunits are configured for being moved between a horizontal position, relative to the ground on which the mobile marking robot is operating, when the device is in its active state, and a vertical position, when the device is in its inactive state.
